(19) United States
(12) Patent Application Publication
(10) Pub. No.: US 2014/0105125 A1
(43) Pub. Date: Apr. 17, 2014

(54) CRITERIA FOR UE-INITIATED BEARER DEACTIVATION WHEN MAXIMUM NUMBER OF ACTIVE BEARERS HAS BEEN REACHED

(71) Applicant: QUALCOMM INCORPORATED, San Diego, CA (US)

(72) Inventors: Lenaig Genevieve Chaponniere, Paris (FR); Stephen William Edge, Escondido, CA (US); Xipeng Zhu, San Diego, CA (US); Shyamal Ramachandran, San Diego, CA (US)

(73) Assignee: Qualcomm Incorporated, San Diego, CA (US)

(21) Appl. No.: 13/776,628

(22) Filed: Feb. 25, 2013

Related U.S. Application Data
(60) Provisional application No. 61/714,675, filed on Oct. 16, 2012.

(51) Int. Cl. H04W 76/06

(52) U.S. Cl. CPC H04W 76/062
USPC 370/329

(57) ABSTRACT

A UE determines a need to deactivate one or more bearer contexts. The UE then selects for deactivation one or more active bearer contexts based on a context selection criteria, to avoid exceeding a maximum number of allowable active bearer contexts for the UE. The context selection criteria may relate to one or more of: current usage of active bearer contexts, information from applications associated with active bearer contexts, priority level of applications associated with active bearer contexts, order of active bearer context creation, measure of data activity through active bearer contexts, quality of service associated with active bearer contexts, type of service, e.g. voice or data, for which bearer contexts were activated, bandwidth allocations of active bearer contexts, a criteria predefined by the UE, network or user, or a random selection. Once one or more active bearer contexts have been selected, the UE deactivates the selected active bearer contexts.

### BACKGROUND

1. Field

The present disclosure relates generally to wireless communication systems, and more particularly, to implementations of user equipment (UE)-initiated bearer deactivation when a UE has reached a maximum number of allowable bearers.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common service that enables different wireless devices to communicate on a municipal, national, regional, and even global level. In a typical network, an access terminal (e.g., a cell phone) connects to the network via an access point whereby traffic flows between the access terminal and a desired endpoint (e.g., a server or a phone) through various network nodes. To facilitate this traffic flow, the network establishes one or more bearers that provide the quality of service (QoS) to be used for the traffic flow. Accordingly, once a bearer is established, the access terminal and the network each maintain bearer context for the bearer. This bearer context includes information that may be used, for example, in conjunction with identifying and processing packets of a given traffic flow. Specifically, the bear context may include a bearer identifier, packet filter information, and QoS information.

In some cases the network sets up a bearer in response to an access-terminal-initiated resource request. For example, when a user initiates a call with an access terminal, the access terminal may send a message to the network requesting the network to set up resources for the call. In response, the network may establish a bearer for the traffic flow for this call.

In the General Packet Radio Service (GPRS) defined by the 3^{rd} Generation Partnership Project (3GPP), the maximum number of simultaneous Packet Data Protocol (PDP) contexts is limited to the maximum number of Network Service Access Point Identifiers (NSAPIs) that can be defined which is eleven. In the Evolved Packet System (EPS) used for Long Term Evolution (LTE) wireless access, the maximum number of simultaneous EPS bearer contexts was aligned by 3GPP with the GPRS requirements and hence was set at eleven. However the user equipment (UE) and the network are not required to support more than eleven simultaneous PDP/EPS bearer contexts, and in practice they typically support a lower number.

When a UE needs to originate an emergency call in the Packet Switched (PS) domain using LTE access or GPRS, it needs to activate at least one bearer context for signaling and another one for user media, (e.g., voice and/or data) i.e., a minimum of two additional bearer contexts. In case the UE is already in normal service with some non-emergency related bearer contexts already active, it is possible that these two additional contexts would bring the total number of simultaneous active bearer contexts beyond the maximum supported by the UE, in which case the UE will need to first deactivate some of the already active bearer contexts before it can proceed with the PS emergency call. Moreover, even without the need to set up a PS emergency call, it is possible that the user may want to access a service requiring one or more additional contexts that can only be activated if already active bearer contexts are deactivated first, so as to stay within the maximum number of allowable simultaneous contexts supported by the UE.

### SUMMARY

In an aspect of the disclosure, a method of wireless communication for a UE, a computer program product for a UE, and a UE are provided. An exemplary UE determines a need to deactivate one or more bearer contexts. The UE then selects for deactivation one or more active bearer contexts based on a context selection criteria, to thereby avoid the UE exceeding a maximum number of allowable active bearer contexts for the UE. The context selection criteria may relate to one or more of: current usage of an active bearer context, information from applications associated with active bearer contexts, priority level of applications associated with active bearer contexts, order of active bearer context creation, measure of data activity through active bearer contexts, quality of service (QoS) associated with active bearer contexts, type of service, e.g. voice or data, for which bearer contexts were activated, bandwidth allocations of active bearer contexts, a criteria predefined by the UE, network or user, or a random selection of active bearer contexts. Once one or more active bearer contexts have been selected by the UE, the UE deactivates the selected one or more of the active bearer contexts.

### BRIEF DESCRIPTION OF THE DRAWINGS

FIG. 1 is a diagram illustrating aspects of a communication system configured to support selection of active bearer context for deactivation.

FIG. 2 is a flowchart of several sample aspects of operations that may be performed to select and deactivate one or more active bearer contexts.

FIG. 3 is a block diagram of several components that may be employed in communication nodes to implement active bearer context selection and deactivation.

FIG. 4 is a call flow diagram illustrating several operations that may be performed to deactivate an active bearer context.

FIG. 5 is a block diagram illustrating an example of an evolved Node B and user equipment in an access network.

FIG. 6 is a flow chart of a method of active bearer context deactivation.

FIG. 7 is a conceptual data flow diagram illustrating the data flow between different modules/means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

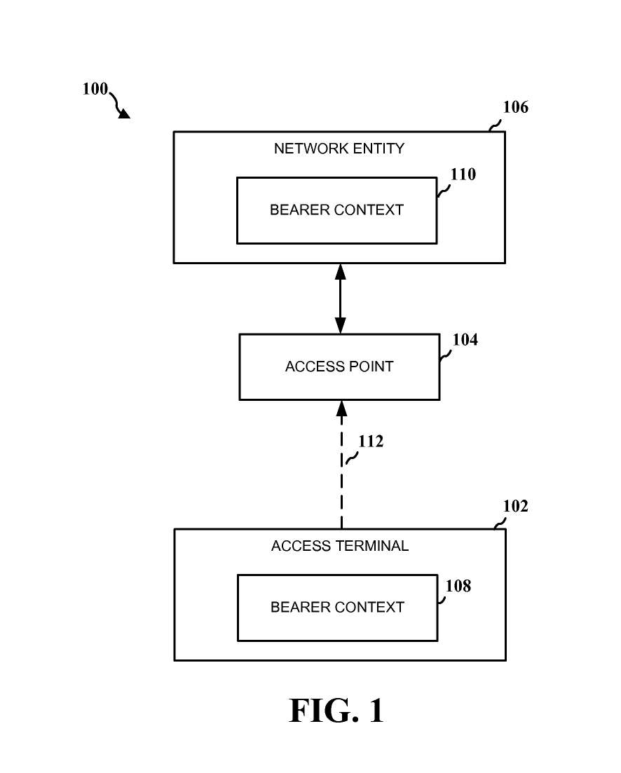

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations or eNodeBs (eNB), access terminals may be referred to or implemented as user equipment (UE) or mobiles, and so on.

Access points in the system 100 provide one or more services (e.g., network connectivity) for one or more wireless terminals that may be installed within or that may roam throughout a coverage area of the system 100. For example, at various points in time the access terminal 102 may connect to an access point 104 or some other access point (not shown). Each access point in the system 100 may communicate with one or more network entities (represented, for convenience, by network entity 106) to facilitate wide area network connectivity. These network entities may take various forms such as, for example, one or more radio and/or core network entities. Thus, in various implementations the network entity 106 may represent functionality such as at least one of: network management (e.g., via an operation, administration, management, and provisioning entity), call control, session management, mobility management, gateway functions, interworking functions, or some other suitable network functionality.

The access terminal 102 and the network entity 106 (e.g., a mobility management entity, MME) maintain information, i.e., bearer context 108 and 110, respectively, for a bearer that the network entity 106 established for traffic flow to and/or from the access terminal 102. In some cases, the network entity 106 may establish this bearer in response to a request for resources from the access terminal. At some later point in time, the access terminal 102 may determine a need to deactivate one or more bearer contexts. In such cases, the access terminal 102 may determine a need to deactivate one or more bearer context. In such cases, the access terminal may send a request to release these resources and, as a result, trigger the release of the related bearer contexts. Alternatively, the access terminal 102 may locally deactivate the bearer context 108. The latter may occur, for example, when the access terminal 102 is not able to communicate with the network entity 106, e.g., due to the access terminal 102 being out of network coverage when the request is sent.

Subsequently, when the access terminal 102 is again able to communicate with the network entity 106, e.g., the access terminal 102 returns to network coverage, the access terminal 102 synchronizes the bearer context 108 with the network entity 106. For example, the access terminal 102 may send a message 112 to the network entity 106 through the access point 104 that indicates that the bearer context 108 has been deactivated. In addition to cases of loss of network connectivity, under present 3GPP specifications, the access terminal 102 may also locally deactivate bearer context 108 if 1) the access terminal has reached the maximum number of contexts and 2) the access terminal needs to activate new contexts for a packet emergency call. In such cases, the access terminal 102 locally deactivates the bearer context 108 and then sends a message to the network entity 106 notifying it of the release of resources. The bearer contexts 108, 110 each provide resources that enable support of a voice and/or data transfer with defined properties and characteristics between the access terminal 102 and network entity 106. Bearer contexts may be used to exchange voice and/or data between the access terminal 102 and one or more remote entities (e.g. one or more other access terminals) via the network entity 106. Bearer contexts 108 and 110 may in some embodiments be referred to as, or correspond to, bearers, contexts, connections, packet flows, packet data flows, IP connections, PDP contexts or some other term.

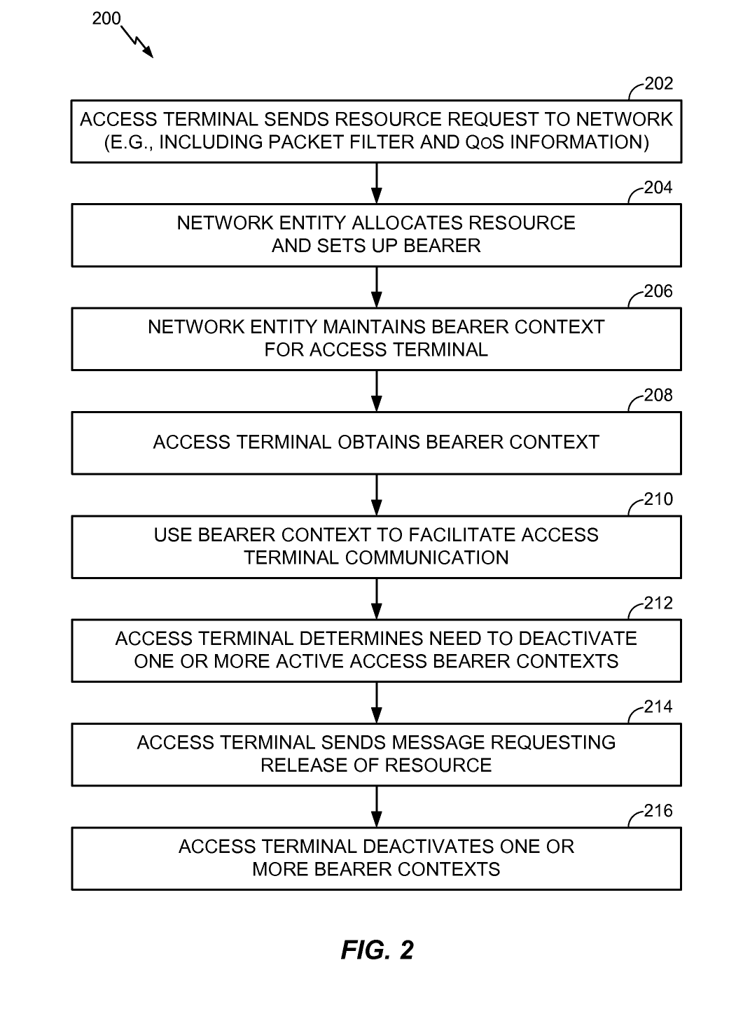

Sample operations that may be employed by the system 100 will now be described in more detail in conjunction with the flowchart of FIG. 2. For convenience, the operations of FIG. 2 (or any other operations discussed or taught herein) may be described as being performed by specific components. It should be appreciated, however, that these operations may be performed by other types of components and may be performed using a different number of components. It also should be appreciated that one or more of the operations described herein may not be employed in a given implementation.

As represented by block 202 of FIG. 2, at some point in time an access terminal sends a resource request to the network (e.g., a network entity such as a packet data network gateway, PGW, or an MME). Such an access-terminal-initiated resource request may be triggered, for example, by a user or an application of the access terminal initiating a traffic flow (e.g., a call, a download, etc.) at the access terminal.

Here, the resource request may comprise a request for Internet Protocol (IP) flow resources from the network. Accordingly, the request may include IP packet filter information and QoS information for the traffic flow.

In some aspects, the QoS information specifies how traffic is to be handled for the traffic flow. For example, the QoS information may specify at least one of: a desired or required level of information loss (e.g., maximum packet loss), a desired or required delay (e.g., maximum packet delay), a desired or required data rate, priority, or some other quality-related characteristic. In LTE-based networks, the QoS information may comprise a quality class identification (QCI) that indicates, for example, the type of delay or packet loss that are expected for an IP packet flow and the type of priority given for that IP packet flow.

In some aspects, the IP packet filter information is used to identify a given IP traffic flow (e.g., packet stream) that is associated with a particular bearer. To this end, an IP packet filter contains information that may be compared with IP header information of a packet that is used to identify the packet. For example, the IP packet filter information may comprise at least one of: a source address, a destination address, a source port, a destination port, or a protocol (e.g., the higher layer protocol that is being used, such as UDP or TCP). In some cases a packet filter may include a wild card address that is defined to match any address and/or a wildcard port that is defined to match any port. In a typical case, a packet filter comprises a 5-tuple including source address, destination address, source port, destination port, and protocol.

As represented by block 204, as a result of the resource request, a network entity (e.g., an MME) will allocate the requested resources and set up an associated bearer (e.g., a dedicated bearer). In some aspects, a bearer defines a logical pipe that specifies how a flow of traffic to and/or from an access terminal is to be handled by the network (e.g., specifies the QoS to be applied to that traffic). Here, the network entity maps the packet filter associated with the resource request to a bearer by establishing a new bearer or by modifying an existing bearer. As an example of the latter case, in the event a bearer having the requested QoS is already set up (e.g., for another packet filter), the network entity may modify that bearer to include the packet filter provided by the request.

As represented by block 206, after the bearer is set up, the network entity maintains bearer context for that bearer. For example, the network entity may store the bearer context in data memory and update the bearer context, as needed. Here, the bearer context comprises a bearer identifier, QoS information, and at least one packet filter.

As represented by block 208, in conjunction with bearer set up, the access terminal obtains the bearer context for the bearer. For example, the access terminal may store the bearer identifier (e.g., sent by the network entity in conjunction with setting up the bearer), the QoS information, and the packet filter(s) for that bearer in a data memory. The access terminal then maintains the bearer context for that bearer (e.g., updating the bearer context, as needed). Here, the access terminal may employ various techniques to associate the resource request (e.g., a packet filter of the request) to the bearer assigned by the network entity.

As one example, the association may be based on a procedure transaction ID (PTI). Here, the access terminal may compare a PTI included in the resource request with a PTI provided in a bearer setup (e.g., bearer establishment or modification) message received from the network entity to determine whether to associate the corresponding bearer with the resource request.

As another example, the association may be based on packet filter identification information. Here, an identifier associated with the packet filter may be sent to the network via the resource request. The network entity may then include that packet filter identifier in the bearer setup message sent to the access terminal. Consequently, the access terminal may compare the sent identifier with the received identifier to determine whether to associate the corresponding bearer with the resource request.

As yet another example, the association may be based on comparison of the packet filter to the traffic filter template of the bearer. Here, when the network entity sends a message to the access terminal in conjunction with setting up the bearer, the network entity may indicate which packet filter is associated with this bearer. The access terminal may then compare the packet filter that was sent with the resource request with the packet filter sent by the network entity to determine whether to associate the corresponding bearer with the resource request.

As represented by block 210, once the bearer is established, the bearer context is used to facilitate communication between the access terminal and some other node (e.g., a phone, a server, etc.) via the network. For example, when the network (e.g., a PGW) receives a packet from the other node, the network will compare the packet header information with the packet filter and assign the packet to the appropriate bearer based on this comparison. In this way, the network may apply the appropriate QoS when routing the packet to the access terminal.

As represented by block 212, at some point in time, the access terminal may determine a need to deactivate one or more active access bearer contexts. This may occur, for example, when a user may want to access a service requiring one or more additional contexts that can only be activated if already active bearer contexts are deactivated first, so as to stay within the maximum number of allowable simultaneous contexts supported by the UE.

As represented by block 214, the access terminal may attempt to send a message to the network entity to request the release of a previously requested resource. For example, a user of the access terminal or an application executing on the access terminal may elect to terminate the traffic flow that was initiated at block 202 (e.g., the user may end a cell phone call or data feed). In this case, the access terminal may send a message indicating that the packet filter(s) and associated QoS should be released. Here, the access terminal initiates the resource release so that the network entity may update its status accordingly (e.g., update state information for existing bearers). For example, under normal circumstances when the network entity does receive the release request, the network entity may deactivate (e.g., release or delete) the assigned bearer, as represented by block 216. Alternatively, at block 214, the access terminal may locally deactivate bearer context 108 and then send a message to the network entity notifying it of the release of resources.

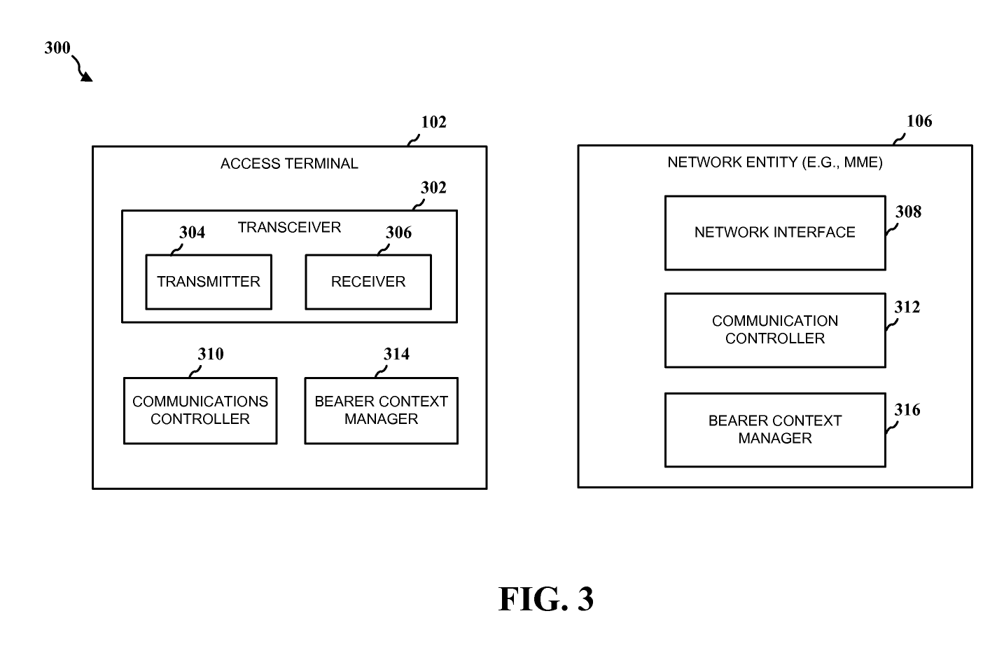

FIG. 3 illustrates several sample components that may be incorporated into nodes such as the access terminal 102 and the network entity 106 to perform bearer context selection and deactivation operations as taught herein. The described components also may be incorporated into other nodes in a communication system. For example, other nodes in a system may include components similar to those described for the access terminal 102 and the network entity 106 to provide similar functionality. In addition, a given node may contain one or more of the described components. For example, an access terminal may contain multiple transceiver components that enable the access terminal to operate on multiple frequencies and/or communicate via different technologies.

As shown in FIG. 3, the access terminal 102 includes a transceiver 302 for communicating with other nodes. The transceiver 302 includes a transmitter 304 for sending signals (e.g., resource requests, resource release requests, and synchronization messages) and a receiver 306 for receiving signals (e.g., bearer setup messages).

The network entity 106 includes a network interface 308 for communicating with other network nodes (e.g., sending bearer setup messages and receiving resource requests, resource release requests, and synchronization messages). For example, the network interface 308 may be configured to communicate with one or more network nodes via a wired or wireless backhaul.

The access terminal 102 and the network entity 106 include other components that may be used in conjunction with bearer context selection and deactivation operations as taught herein. For example, the access terminal 102 and the network entity 106 may include communication controllers 310 and 312, respectively, for managing communication with other nodes (e.g., sending and receiving messages, requests, and indications) and for providing bearer context selection and other related functionality (e.g., as taught herein). In addition, the access terminal 102 and the network entity 106 may include bearer context managers 314 and 316, respectively, for managing bearer context (e.g., setting up, obtaining, maintaining, deactivating, and determining bearer context and updating status) and for providing other related functionality (e.g., as taught herein).

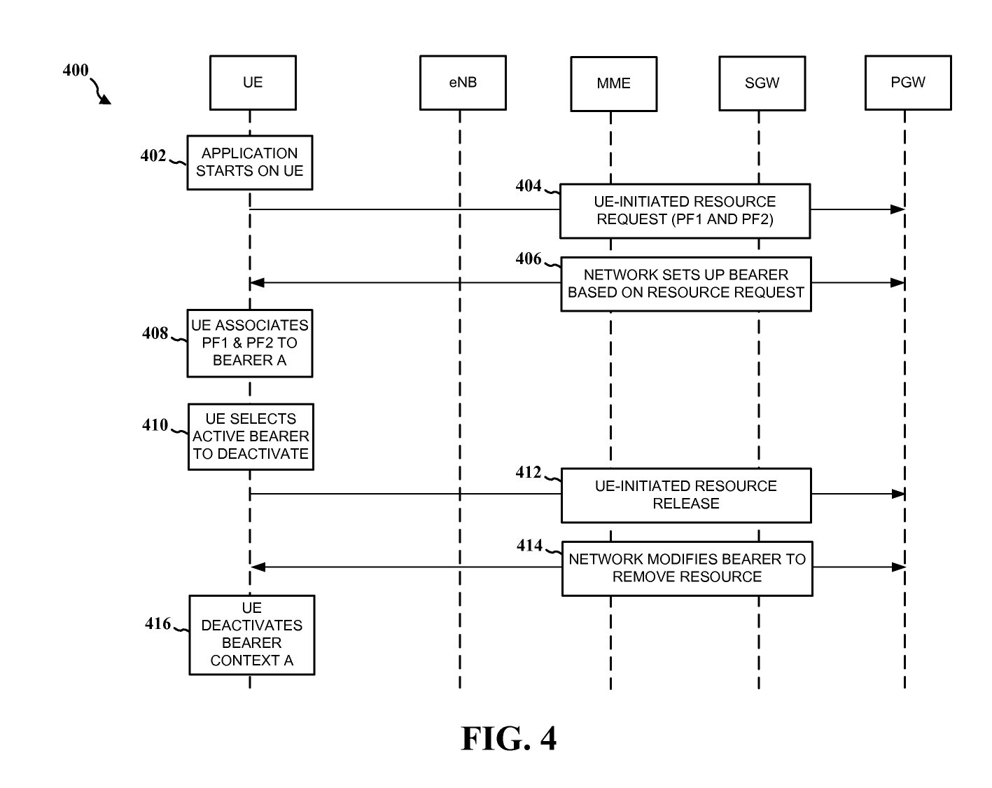

Referring now to FIG. 4, for purposes of illustration sample bearer management operations 400 will be described in the context of an LTE-based network. Accordingly, LTE terminology with be used in this example. It should be appreciated that these operations may be applicable to other types of networks.

As illustrated, signals to and from a UE are routed through a plurality of network entities including an enhanced node B (eNB), MME, serving gateway (SGW), and PGW. The illustrated operational flow begins at block 402 with, for example, the launch of an application on the UE. As represented by block 404, the UE requests resources from the network, which triggers the network to set up a bearer at block 406. In this example, the resource request identifies two packet filters designated PF1 and PF2. As described herein, when the UE requests resources from the network, the UE maintains association information between the packet filters and the allocated bearer at block 408. For this particular example, PF1 and PF2 are associated with a bearer context A.

As represented by block 410, at some point in time the UE may determine a need to deactivate one or more bearer contexts in order to provide for available activation of one or more bearer contexts for other purposes. For example, a UE may need to make an emergency call requiring one bearer context for voice data and another bearer context for data services. In order to make bearer contexts available the UE selects an active context bearer to deactivate using one or more selection criteria described in detail below. Once the UE selects the active bearer context, it sends a resource release request as represented by block 412. At block 414, the network modifies the bearer associated with the selected bearer context to remove related resources. As represented by block 416, the UE deactivates the selected bearer context, e.g., bearer context A. Alternatively, instead of sending a resource release request, the UE may locally deactivate the selected bearer context and then send a message to the network entity notifying it of the release of resources (not shown in FIG. 4).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where N_{S}</=min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

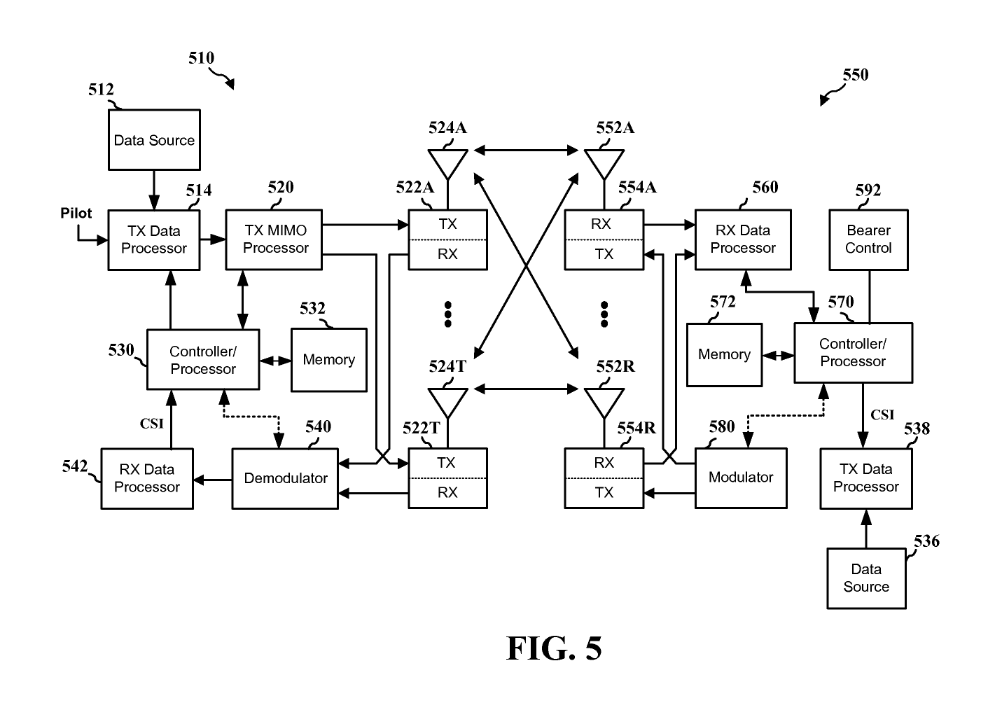

FIG. 5 illustrates a wireless device 510 (e.g., an access point, base station, eNB) and a wireless device 550 (e.g., an access terminal, UE) of a sample MIMO system. At the device 510, traffic data for a number of data streams is provided from a data source 512 to a transmit (TX) data processor 514. Each data stream may then be transmitted over a respective transmit antenna.

The TX data processor 514 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 530. A data memory 532 may store program code, data, and other information used by the processor 530 or other components of the device 510.

The modulation symbols for all data streams are then provided to a TX MIMO processor 520, which may further process the modulation symbols (e.g., for OFDM). The TX MIMO processor 520 then provides N_{T} modulation symbol streams to N_{T} transceivers (XCVR) 522A through 522T. In some aspects, the TX MIMO processor 520 applies beam-forming weights to the symbols of the data streams and to the antenna from which the symbol is being transmitted.

Each transceiver 522 receives and processes a respective symbol stream to provide one or more analog signals, and further conditions, e.g., amplifies, filters, and up converts, the analog signals to provide a modulated signal suitable for transmission over the MIMO channel. N_{T} modulated signals from transceivers 522A through 522T are then transmitted from N_{T} antennas 524A through 524T, respectively.

At the device 550, the transmitted modulated signals are received by N_{R} antennas 552A through 552R and the received signal from each antenna 552 is provided to a respective transceiver (XCVR) 554A through 554R. Each transceiver 554 conditions, e.g., filters, amplifies, and down converts, a respective received signal, digitizes the conditioned signal to provide samples, and further processes the samples to provide a corresponding “received” symbol stream.

A receive (RX) data processor 560 then receives and processes the N_{R} received symbol streams from N_{R} transceivers 554 based on a particular receiver processing technique to provide N_{T} “detected” symbol streams. The RX data processor 560 then demodulates, deinterleaves, and decodes each detected symbol stream to recover the traffic data for the data stream. The processing by the RX data processor 560 is complementary to that performed by the TX MIMO processor 520 and the TX data processor 514 at the device 510.

A processor 570 periodically determines which pre-coding matrix to use (discussed below). The processor 570 formulates a reverse link message comprising a matrix index portion and a rank value portion. A data memory 572 may store program code, data, and other information used by the processor 570 or other components of the device 550.

The reverse link message may comprise various types of information regarding the communication link and/or the received data stream. The reverse link message is then processed by a TX data processor 538, which also receives traffic data for a number of data streams from a data source 536, modulated by a modulator 580, conditioned by the transceivers 554A through 554R, and transmitted back to the device 510.

At the device 510, the modulated signals from the device 550 are received by the antennas 524, conditioned by the transceivers 522, demodulated by a demodulator (DEMOD) 540, and processed by a RX data processor 542 to extract the reverse link message transmitted by the device 550. The processor 530 then determines which pre-coding matrix to use for determining the beam-forming weights then processes the extracted message.

FIG. 5 also illustrates that the communication components may include one or more components that perform bearer context-related operations as taught herein. For example, a bearer control component 592 may cooperate with the processor 570 and/or other components of the device 550 to send/receive signals to/from another device (e.g., device 510) using bearer context or to manage bearer context. It should be appreciated that for each device 510 and 550 the functionality of two or more of the described components may be provided by a single component. For example, a single processing component may provide the functionality of the bearer control component 592 and the processor 570.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM.®., etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO RelO, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, a WiFi access point, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

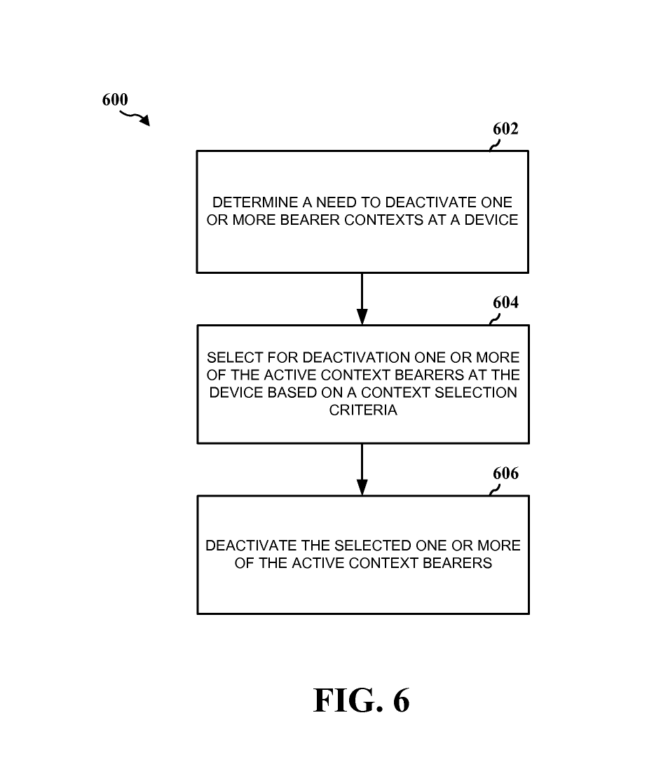

FIG. 6 is a flow chart 600 of a method of wireless communication for a UE. At step 602, the UE determines a need to deactivate one or more bearer contexts. This may occur, for example, when the user wants to run an application or access a service that requires one or more additional bearer contexts. In some cases the maximum number of allowable supported simultaneous contexts may have already been reached at the UE. Thus, deactivation of one or more active bearer context may be necessary in order to allow the additional context needed for the UE to run the application or access the service.

At step 604, the UE selects for deactivation one or more active bearer contexts based on a context selection criteria in order to avoid the UE exceeding a maximum number of allowable active bearer contexts for the UE. The UE may use one or more of the following criteria to select one or more active contexts for deactivation from among a plurality of active bearer contexts:

A: The UE may select a context that is not associated with any application that is currently active on the UE. This criterion may be satisfied if the application that triggered activation of the context being considered for deactivation has been closed, and no other application has used the context within a predefined period of time.

B: The UE may select a context using the optimal page replacement (OPT) rule wherein each context may be treated in a similar manner to a page of computer memory for the OPT rule. Under this rule, the UE may select a context for deactivation in a similar manner to selection of a page for replacement based on the information of the application associated with that context. Such information may include the time until predicted next usage of the context, and importance of the application.

C: The UE may select the context that was activated first, thus applying a first-in-first out (FIFO) selection process. Alternatively, criterion C may be based on last-in-first-out (LIFO) selection process, wherein the UE may select the context that was activated last.

D: The UE may select a context based on a measure of activity through the context, wherein activity corresponds to both the sending and receiving of data. For example, the measure may relate to the volume of activity through the context and the measure itself may be a ratio of recent activity to long-term activity, defined as follows: amount of data received/sent over a recent time window T1 divided by the amount of data received/sent over a long-term time window T2, with T2 much greater than T1. The context with the smallest ratio, which corresponds to the least amount of recent activity, is selected for deactivation.

E: The UE may select a context for which no data has been sent or received for the longest amount of time among a plurality of currently active contexts for which no data has been sent or received for more than a period of time, e.g., X minutes.

F: The UE may select a context with the lowest priority Quality of Service (QoS) attributes (e.g. delay class, precedence class, traffic class, etc), where priority of QoS attributes may be decided by a user, network operator or terminal vendor and may, for example, prioritize attributes according to how demanding they are on network and terminal resources.

G: The UE may select a context that was activated for data services over a context that was activated for voice services.

H: The UE may select a context based on an order or priority defined at a network level by an operator, terminal vendor or operating system provider. The choice of context selection for deactivation may be pre-configured, configured at the time when the last of the supported context is being setup—provided the network knows the maximum number of bearers the UE supports—or configured upon activation of every new context.

I: The UE may select a context whose associated application has lowest priority where priority of an application may be configured by a terminal vendor, operating system provider, network operator, application provider or user. When a context is associated with more than one application, the application with highest priority is used to determine deactivation.

J: The UE may select a context based on a combination of one or more of the criteria A, B, C, D, E, F. G. H and I wherein (i) the criteria may be prioritized and evaluated in priority order in order to select a context or (ii) the criteria may be used to assign weighting factors to different contexts which are subsequently evaluated to determine a particular context (e.g. the one with the lowest or highest set of weighting factors) or (iii) the criteria may be combined in some other way.

With continued reference to FIG. 6, finally, at step 606, the UE deactivates the selected one or more of the active bearer contexts.

In order to minimize the impact on user experience due to context deactivation, the UE may apply the various criteria listed above using the following steps (which may provided one embodiment of the criteria J above) in the order shown, where the steps are executed until the required number of additional contexts have been deactivated:

1: Let N be the number of additional contexts needed, either due to PS emergency call set-up or new non-emergency-related service request from the user, beyond the maximum number of simultaneous active contexts supported by the UE.

2: Apply criteria A.
a. If more than N contexts meet criteria A, select N contexts among them by applying criteria C, and deactivate them. The procedure ends at this point.
b. Else, if N contexts meet criteria A, deactivate them. The procedure ends at this point.
c. Else, if less than N contexts meet criteria A, deactivate all contexts that meet criteria A. Let K be the number of deactivated contexts. The remaining number of contexts to select for deactivation is now (N-K).

3: If H exists, i.e., operator criteria have been configured:
a. Apply criteria H. If more than (N-K) context meets criteria H, select (N-K) contexts among them by applying criteria C, and deactivate them. The procedure ends at this point.
b. Else, if (N-K) contexts meet criteria H, deactivate them. The procedure ends at this point.
c. Else, if less than (N-K) contexts meet criteria H, deactivate all contexts that meet criteria H. Let L be the number of deactivated contexts. The remaining number of contexts to select for deactivation is now (N-K-L).

4: If I exists, i.e. application priorities have been configured, deactivate the (N-K-I) contexts associated with the lowest priority applications. One or more of criteria D, E, F and G may be used (e.g. according to a weighted average) to prioritize contexts associated with equal priority applications if needed.

5: If I is not used and if the UE has the necessary information to apply criteria B, select (N-K-L) contexts to be deactivated using criteria B. The procedure ends at this point.

6: If the UE does not have the necessary information to apply criteria B or I, apply a weighted average of criteria D, E, F and G to select (N-K-L) contexts to be deactivated. The procedure ends at this point.

The foregoing is one example of applying a combination of context selection criteria. Others are possible. For example, another selection algorithm may be as follows:

1. Select a bearer which has no associated application. The application which triggered activation of the bearer has been closed and no other applications use it in a predefined period. When there are multiple of such bearers, FIFO and/or least recent used (LRU) rule can be used to select one bearer. This rule does not have the issue of application triggered bearer re-activation.

2. If no bearer meets criteria #1, an OPT rule may be used. This rule requires that the operating system/UE be aware of applications. In this case, the UE selects the bearer based on information of associated application. Such information may include the predicated next usage of the bearer, or the importance of the application/bearer.

3. If #2 is not applicable because the UE does not have such information of applications, then the LRU rule may be used.

Looking more closely at deactivation criteria, it may be assumed that some data applications will send data autonomously and not directly to or from the user, that real time transport protocol (RTP) idle packets may be periodically sent on a voice connection when not in active use and that more recently established bearers may be statistically more important than ones established for a long time. To address these assumptions, several of the criteria listed above consider the following when making selections: (a) how recently a bearer was established—with higher priority, in terms of preservation, being assigned to more recently established bearers (criteria C); (b) whether the service for which the context bearer is being used is voice related or data related—with higher priority being assigned for voice, on the assumption that a voice associated bearer may sometimes be related to the emergency call (criteria G); (c) volume of activity within a recent time window compared to long term average activity (if measurable) with higher priority being assigned to higher activity recently (criteria D).

It is possible that an application associated with an EPS bearer context that has been deactivated may reactivate the bearer context soon after deactivation, thereby removing the availability of the context to the UE for the intended purpose, e.g., emergency call. To ensure the deactivate context remains deactivated so that the emergency PDN connection may be established before the normal application initiated EPS bearer reactivation, the associated application may be prevented from reactivating the deactivated context for some minimum time period—e.g., by providing information to the application itself or to the UE operating system about this restriction or by maintaining a minimum time interval for bearer reactivation for all applications.

In general, the bearer context selected for deactivation may be that bearer that: was created last, was created first (which is not the default bearer), has the least amount of data flowing through in the last X seconds, has the highest amount of data flowing in the last X seconds, has the lowest bandwidth allocation, has the highest bandwidth allocation, has the lowest bearer number (which is not the default bearer), has the highest bearer number. In addition, the bearer may be selected randomly. The bearer may also be selected based on user input. In this configuration, the UE prompts the user regarding which application or service to drop in order to deactivate a context bearer.

Returning to FIG. 6, the selection step 604 may include one or more of the selection criteria described above, a plurality of selection criteria executed in an ordered process, a weighted combination of several criteria, or a random selection of one or more criteria. For example, an active bearer context that is not associated with an application that is currently active on the device may be selected.

An active bearer context may be selected out of a plurality of active bearer contexts, based on information from applications associated with the plurality of active bearer contexts. In this case, the information may include one or more of a time until predicted next usage of the context, and an importance level of the application. The importance level can be identified from the QoS information associated with the active bearer context or one or more port numbers used by the active bearer context.

An active bearer context may be selected based on order of bearer creation among a plurality of active bearer contexts. For example, the first context activated out of the plurality of active bearer contexts may be selected, provided it is not a default bearer. Alternatively, the last context activated out of the plurality of active bearer contexts may be selected.

An active bearer context may be selected out of a plurality of active bearer contexts based on a measure of data activity through the bearer as a function of time. The measure of data activity may be a volume of data passing through the bearer over a recent period of time. Furthermore, the measure may be a comparison of the volume of data over the recent period of time and a long-term average volume of data passing through the bearer. The bearer having the lowest measure of data activity may be selected. Alternatively, the bearer having the highest measure of data activity may be selected.

An active bearer context which has gone the longest time without transmitting, e.g., receiving or sending, data out of a plurality of active bearer contexts may be selected. An active bearer context which has a lowest priority QoS of a plurality of active bearer contexts may be selected. An active bearer context which was activated for data services out of a plurality of active bearer contexts may be selected over active bearer contexts which have been activated for voice services.

An active bearer context may be selected out of a plurality of active bearer contexts, based on predefined criteria. An active bearer context which is associated with an application having a lowest priority level out of a plurality of active bearer contexts may be selected. An active bearer context may be selected out of a plurality of active bearer contexts based on the respective bandwidth allocations of each active bearer. In this case, the bearer having the lowest bandwidth may be selected. Alternatively, the bearer having the highest bandwidth may be selected.

An active bearer context out of a plurality of active bearer contexts may be selected based on the number of the active bearer context. For example, the bearer having the lowest number may be selected, provided it is not a default bearer. Alternatively, the bearer having the highest number may be selected. An active bearer context may be selected randomly out of a plurality of active bearer contexts.

An active bearer context may be selected out of a plurality of active bearer contexts in the following order: First, an active bearer context that is not associated with an application that is currently active on the device is selected; otherwise, an active bearer context is selected based on a predefined criteria; otherwise, an active bearer context associated with an application having a lowest priority level is selected; and otherwise, an active bearer context is selected based on information from applications associated with the plurality of active bearer contexts.

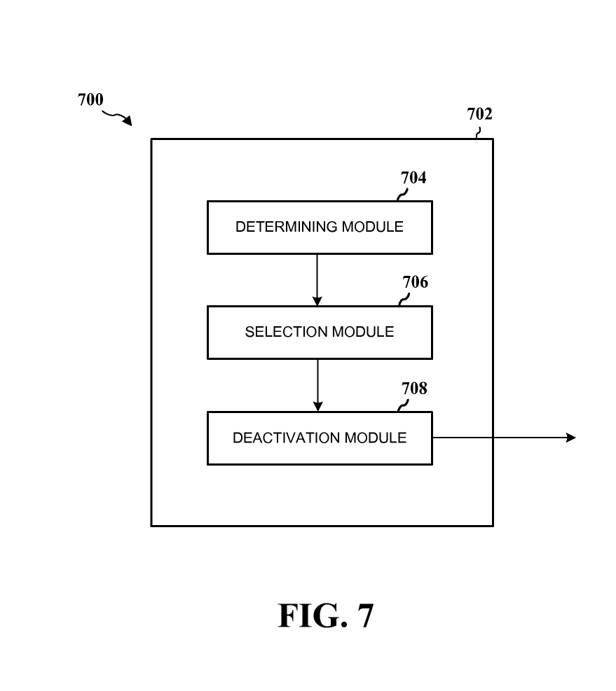

FIG. 7 is a conceptual data flow diagram 700 illustrating the data flow between different modules/means/components in an exemplary apparatus 702. The apparatus may be a UE. The UE 702 includes a module 704 that determines a need to activate one or more bearer contexts, and a module 706 that selects, for deactivation, one or more active bearer contexts based on a context selection criteria, in order to avoid the UE exceeding a maximum number of allowed active bearer contexts for the UE. The UE 702 also includes a module 708 that deactivates the selected one or more of the active bearer contexts.

The UE 702 may include additional modules that perform each of the steps of the algorithm in the aforementioned flow chart of FIG. 6 and the detailed steps set forth above regarding step 604 of FIG. 6. As such, each step in the aforementioned flow charts of FIG. 6 or described above may be performed by a module and the UE 702 may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

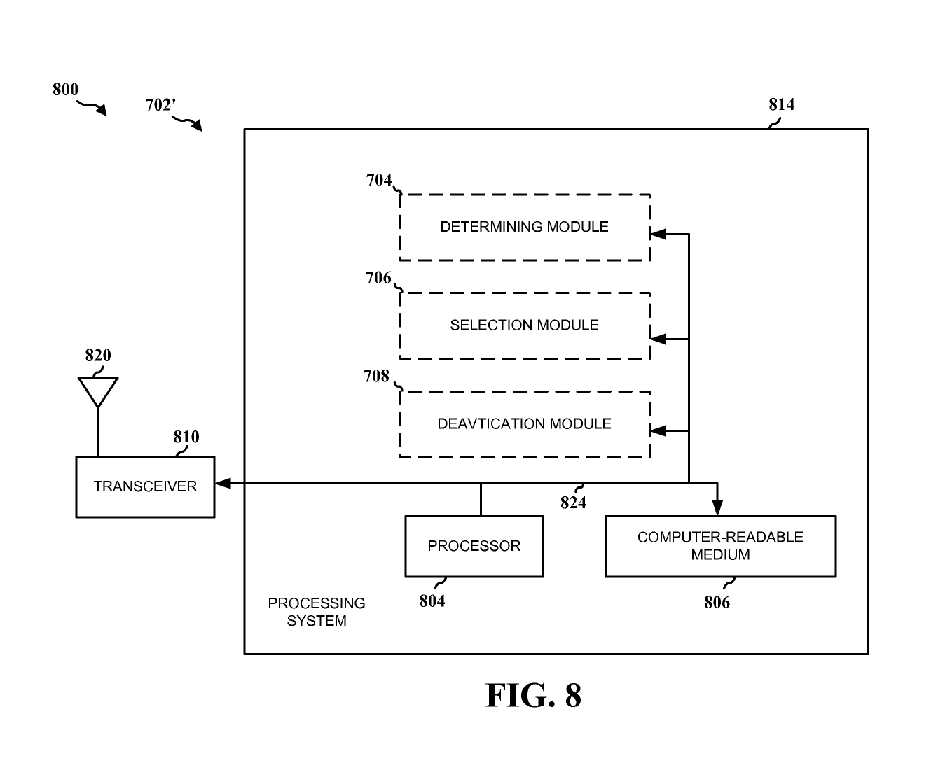

FIG. 8 is a diagram 800 illustrating an example of a hardware implementation for a UE 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, and the computer-readable medium 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814. In addition, the transceiver 810 receives information from the processing system 814, and based on the received information, generates a signal to be applied to the one or more antennas 820. The processing system 814 includes a processor 804 coupled to a computer-readable medium 806. The processor 804 is responsible for general processing, including the execution of software stored on the computer-readable medium 806. The software, when executed by the processor 804, causes the processing system 814 to perform the various functions described supra for any particular apparatus. The computer-readable medium 806 may also be used for storing data that is manipulated by the processor 804 when executing software. The processing system further includes at least one of the modules 704, 706, and 708. The modules may be software modules running in the processor 804, resident/stored in the computer readable medium 806, one or more hardware modules coupled to the processor 804, or some combination thereof. The processing system 814 may be a component of the UE 550 (FIG. 5) and may include the memory 572 and/or at least one of the TX processor 538, the RX processor 560, and the controller/processor 570.

In one configuration, the UE 702/702′ for wireless communication includes means for determining a need to activate one or more bearer contexts, and means for selecting for deactivation one or more active bearer contexts based on a context selection criteria, to avoid the UE exceeding a maximum number of allowed active bearer contexts for the UE. The UE 702/702′ further includes means for deactivating the selected one or more of the active bearer contexts.

The aforementioned means may be one or more of the aforementioned modules of the UE 702 and/or the processing system 814 of the UE 702′ configured to perform the functions recited by the aforementioned means. As described supra, the processing system 814 may include the TX processor 538, the RX processor 560, and the controller/processor 570. As such, in one configuration, the aforementioned means may be the TX processor 538, the RX processor 560, and the controller/processor 570 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), said method comprising:
determining a need to deactivate one or more bearer contexts; and
selecting for deactivation one or more active bearer contexts based on a context selection criteria, to avoid the UE exceeding a maximum number of allowable active bearer contexts for the UE.

2. The method of claim 1, further comprising deactivating the selected one or more of the active bearer contexts.

3. The method of claim 1, wherein selecting for deactivation comprises selecting an active bearer context that is not associated with an application that is currently active on the UE.

4. The method of claim 3, further comprising:
deactivating the selected active bearer context; and
preventing the application from reactivating the deactivated bearer context.

5. The method of claim 1, wherein selecting for deactivation comprises selecting an active bearer context out of a plurality of active bearer contexts, based on information from applications associated with the plurality of active bearer contexts.

6. The method of claim 5, wherein the information comprises one or more of a time until predicted next usage of the context, and an importance level of the application.

7. The method of claim 6, wherein the importance level can be identified from QoS information associated with the active bearer context or one or more port numbers used by the active bearer context.

8. The method of claim 1, wherein selecting for deactivation comprises selecting an active bearer context based on order of bearer creation among a plurality of active bearer contexts.

9. The method of claim 8, wherein the first context activated out of the plurality of active bearer contexts is selected, provided it is not a default bearer.

10. The method of claim 8, wherein the last context activated out of the plurality of active bearer contexts is selected.

11. The method of claim 1, wherein selecting for deactivation comprises selecting an active bearer context out of a plurality of active bearer contexts based on a measure of data activity through the bearer as a function of time.

12. The method of claim 11, wherein the measure of data activity comprises a volume of data passing through the bearer over a recent period of time.

13. The method of claim 12, wherein the measure comprises a comparison of the volume of data over the recent period of time and a long-term average volume of data passing through the bearer.

14. The method of claim 11, wherein the bearer having the lowest measure of data activity is selected.

15. The method of claim 11, wherein the bearer having the highest measure of data activity is selected.

16. The method of claim 1, wherein selecting for deactivation comprises selecting an active bearer context out of a plurality of active bearer contexts, which has a longest time without transmitting data.

17. The method of claim 1, wherein selecting for deactivation comprises selecting an active bearer context out of a plurality of active bearer contexts, which has a lowest priority QoS.

18. The method of claim 1, wherein selecting for deactivation comprises selecting an active bearer context out of a plurality of active bearer contexts, which was activated for data services.

19. The method of claim 1, wherein selecting for deactivation comprises selecting an active bearer context out of a plurality of active bearer contexts, based on a predefined criteria.

20. The method of claim 1, wherein selecting for deactivation comprises selecting an active bearer context out of a plurality of active bearer contexts, which is associated with an application having a lowest priority level.

21. The method of claim 1, wherein each bearer has a bandwidth allocation and selecting for deactivation comprises selecting an active bearer context out of a plurality of active bearer contexts based on the bandwidth allocations.

22. The method of claim 21, wherein the bearer having the lowest bandwidth is selected.

23. The method of claim 21, wherein the bearer having the highest bandwidth is selected.

24. The method of claim 1, wherein each bearer has a number and selecting for deactivation comprises selecting an active bearer context out of a plurality of active bearer contexts based on the number.

25. The method of claim 24, wherein the bearer having the lowest number is selected, provided it is not a default bearer.

26. The method of claim 24, wherein the bearer having the highest number is selected.

27. The method of claim 1, wherein selecting for deactivation comprises randomly selecting an active bearer context out of a plurality of active bearer contexts.

28. The method of claim 1, wherein selecting for deactivation comprises selecting an active bearer context out of a plurality of active bearer contexts in the following order:
selecting an active bearer context that is not associated with an application that is currently active on the UE;
otherwise, selecting an active bearer context based on predefined criteria;
otherwise, selecting an active bearer context associated with an application having a lowest priority level; and
otherwise, selecting an active bearer context based on information from applications associated with the plurality of active bearer contexts.

29. An user equipment (UE) for wireless communication, said UE comprising:
means for determining a need to deactivate one or more bearer contexts; and
means for selecting for deactivation one or more active bearer contexts based on a context selection criteria, to avoid the UE exceeding a maximum number of allowable active bearer contexts for the UE.

30. The UE of claim 28, further comprising means for deactivating the selected one or more of the active bearer contexts.

31. The UE of claim 29, wherein the means for selecting for deactivation is configured to select an active bearer context that is not associated with an application that is currently active on the UE.

32. The UE of claim 31, wherein the means for selecting for deactivation is further configured to:
deactivate the selected active bearer context; and
prevent the application from reactivating the deactivated bearer context.

33. The UE of claim 29, wherein the means for selecting for deactivation is configured to select an active bearer context out of a plurality of active bearer contexts, based on information from applications associated with the plurality of active bearer contexts.

34. The UE of claim 33, wherein the information comprises one or more of a time until predicted next usage of the context, and an importance level of the application.

35. The UE of claim 34, wherein the importance level can be identified from QoS information associated with the active bearer context or one or more port numbers used by the active bearer context.

36. The UE of claim 29, wherein the means for selecting for deactivation is configured to select an active bearer context based on order of bearer creation among a plurality of active bearer contexts.

37. The UE of claim 36, wherein the first context activated out of the plurality of active bearer contexts is selected, provided it is not a default bearer.

38. The UE of claim 36, wherein the last context activated out of the plurality of active bearer contexts is selected.

39. The UE of claim 29, wherein the means for selecting for deactivation is configured to select an active bearer context out of a plurality of active bearer contexts based on a measure of data activity through the bearer as a function of time.

40. The UE of claim 39, wherein the measure of data activity comprises a volume of data passing through the bearer over a recent period of time.

41. The UE of claim 40, wherein the measure comprises a comparison of the volume of data over the recent period of time and a long-term average volume of data passing through the bearer.

42. The UE of claim 39, wherein the bearer having the lowest measure of data activity is selected.

43. The UE of claim 39, wherein the bearer having the highest measure of data activity is selected.

44. The UE of claim 29, wherein the means for selecting for deactivation is configured to select an active bearer context out of a plurality of active bearer contexts, which has a longest time without transmitting data.

45. The UE of claim 29, wherein the means for selecting for deactivation is configured to select an active bearer context out of a plurality of active bearer contexts, which has a lowest priority QoS.

46. The UE of claim 29, wherein the means for selecting for deactivation is configured to select an active bearer context out of a plurality of active bearer contexts, which was activated for data services.

47. The UE of claim 29, wherein the means for selecting for deactivation is configured to select an active bearer context out of a plurality of active bearer contexts, based on a predefined criteria.

48. The UE of claim 29, wherein the means for selecting for deactivation is configured to select an active bearer context out of a plurality of active bearer contexts, which is associated with an application having a lowest priority level.

49. The UE of claim 29, wherein each bearer has a bandwidth allocation and the means for selecting for deactivation is configured to select an active bearer context out of a plurality of active bearer contexts based on the bandwidth allocations.

50. The UE of claim 49, wherein the bearer having the lowest bandwidth is selected.

51. The UE of claim 49, wherein the bearer having the highest bandwidth is selected.

52. The UE of claim 29, wherein each bearer has a number and the means for selecting for deactivation is configured to select an active bearer context out of a plurality of active bearer contexts based on the number.

53. The UE of claim 52, wherein the bearer having the lowest number is selected, provided it is not a default bearer.

54. The UE of claim 52, wherein the bearer having the highest number is selected.

55. The UE of claim 29, wherein the means for selecting for deactivation is configured to randomly select an active bearer context out of a plurality of active bearer contexts.

56. The UE of claim 29, wherein the means for selecting for deactivation is configured to select an active bearer context out of a plurality of active bearer contexts in the following order:
select an active bearer context that is not associated with an application that is currently active on the UE;
otherwise, select an active bearer context based on predefined criteria;
otherwise, select an active bearer context associated with an application having a lowest priority level; and
otherwise, select an active bearer context based on information from applications associated with the plurality of active bearer contexts.

57. A user equipment (UE) for wireless communication, said UE comprising:
a processing system configured to:
determine a need to deactivate one or more bearer contexts; and
select for deactivation one or more active bearer contexts based on a context selection criteria, to avoid the UE exceeding a maximum number of allowable active bearer contexts for the UE.

58. The apparatus of claim 57, wherein the processing system is further configured to deactivate the selected one or more of the active bearer contexts.

59. A computer program product for a user equipment (UE), said product comprising:
a computer-readable medium comprising code for:
determining a need to deactivate one or more bearer contexts; and
selecting for deactivation one or more active bearer contexts based on a context selection criteria, to avoid the UE exceeding a maximum number of allowable active bearer contexts for the UE.

60. The product of claim 59, wherein the computer-readable medium further comprises code for deactivating the selected one or more of the active bearer contexts.
